(19) United States
(12) Patent Application Publication
(10) Pub. No.: US 2026/0080629 A1
(43) Pub. Date: Mar. 19, 2026

(54) MEDIA RESOURCE PROCESSING

(71) Applicant: Beijing Zitiao Network Technology Co., Ltd., Beijing (CN)

(72) Inventors: Yuan Yao, Beijing (CN); Zeming Bai, Beijing (CN)

(21) Appl. No.: 19/312,601

(22) Filed: Aug. 28, 2025

(30) Foreign Application Priority Data
Sep. 14, 2024 (CN) 202411296347.5

(51) Int. Cl. G06T 19/00; G06F 3/0484

(52) U.S. Cl. CPC G06T 19/00; G06F 3/0484; G06T 2200/24

(57) ABSTRACT

According to an embodiment of the disclosure, there are provided a method, an apparatus, a device, a storage medium, and a program product for processing a media resource. The method includes: executing a media resource based on a selection of the media resource; determining, during an execution of the media resource and in response to an object creation request triggered by the media resource, a number of a set of objects generated by the media resource, where the set of objects is determined based on object category information indicated by the object creation request; creating, in response to the number being less than a threshold, a first object corresponding to the object category information; and displaying the created first object in the interface.

### CROSS-REFERENCE

The present application claims priority to Chinese Patent Application No. 202411296347.5, filed on Sep. 14, 2024 and entitled “METHOD, APPARATUS, DEVICE, STORAGE MEDIUM AND PROGRAM PRODUCT FOR PROCESSING MEDIA RESOURCE”, the entirety of which is incorporated herein by reference.

### FIELD

Example embodiments of the present disclosure generally relate to the field of computers, and more particularly, to media resource processing.

### BACKGROUND

With the development of computer technologies, more and more users create and share media content through an Internet platform. During the creation process of media content, various types of media resources (e.g., effects, filters) and the like may assist a user in creating richer media content, thereby improving the creation effect of the media content.

### SUMMARY

In a first aspect of the present disclosure, a method for processing a media resource is provided. The method comprises: executing a media resource based on a selection of the media resource; determining, during an execution of the media resource and in response to an object creation request triggered by the media resource, a number of a set of objects generated by the media resource, where the set of objects is determined based on object category information indicated by the object creation request; creating, in response to the number being less than a threshold, a first object corresponding to the object category information; and displaying the created first object in the interface.

In a second aspect of the present disclosure, an apparatus for processing a media resource is provided. The apparatus comprises: an execution module, configured to execute a media resource based on a selection of the media resource; a determining module, configured to determine, during execution of the media resource and in response to an object creation request triggered by the media resource, a number of a set of objects generated by the media resource, where the set of objects is determined based on object category information indicated by the object creation request; and a creating module configured to create, in response to the number being less than a threshold, a first object corresponding to the object category information; and a displaying module, configured to display the created first object in an interface.

In a third aspect of the present disclosure, an electronic device is provided. The device comprises at least one processor; and at least one memory coupled to the at least one processor and storing instructions for being executed by the at least one processor, the instructions, when executed by the at least one processor, causing the device to perform the method of the first aspect.

In a fourth aspect of the present disclosure, a computer-readable storage medium is provided. The computer-readable storage medium stores a computer program thereon, the computer program being executable by a processor to implement the method of the first aspect.

In a fifth aspect of the present disclosure, a computer program product is provided. The computer program product comprises computer-executable instructions that, when executed by a processor, implementing the method of the first aspect.

It should be understood that the content described in this Summary section is not intended to limit the key features or important features of the embodiments of the disclosure, nor is it intended to limit the scope of the disclosure. Other features of the disclosure will become readily understood from the following description.

### BRIEF DESCRIPTION OF DRAWINGS

The above and other features, advantages, and aspects of various embodiments of the disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure can be implemented;

FIG. 2A to FIG. 2B illustrate schematic diagrams of an interaction interface according to some embodiments of the present disclosure;

FIG. 3 illustrates a schematic diagram of an editing interface according to some embodiments of the present disclosure;

FIG. 4 illustrates a flowchart of a process of processing a media resource according to some embodiments of the present disclosure;

FIG. 5 illustrates a schematic structural block diagram of an apparatus for processing a media resource according to some embodiments of the present disclosure;

FIG. 6 illustrates a block diagram of an electronic device capable of implementing a plurality of embodiments of the present disclosure.

### DETAILED DESCRIPTION

Embodiments of the disclosure will be described in more detail below with reference to the accompanying drawings. While certain embodiments of the disclosure are shown in the accompanying drawings, it should be understood that the disclosure may be implemented in various forms and should not be construed as limited to the embodiments set forth herein, but rather, these embodiments are provided for a more thorough and complete understanding of the disclosure. It should be understood that the drawings and embodiments of the disclosure are for exemplary purposes only and are not intended to limit the scope of the disclosure.

It should be noted that the title of any section/subsection provided herein is not limiting. Various embodiments are described throughout and any type of embodiments may be included in any section/subsection. Furthermore, the embodiments described in any section/subsection may be combined with any other embodiment described in the same section/subsection and/or different sections/subsections in any manner.

In the description of the embodiments of the disclosure, the terms “comprising”, “including” and the like should be understood to open-ended, i.e., “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, acquisition and/or use of data, and the like. These aspects all follow the corresponding laws and regulations and related regulations. In the embodiments of the present disclosure, all data is collected, obtained, processed, processed, forwarded, used, etc., all of which are performed on the premise that the user knows and confirms. Accordingly, when implementing the embodiments of the present disclosure, the user should be informed of the types, use ranges, usage scenario, and the like of the data or information that probably involved in an appropriate manner according to relevant laws and regulations and the authorization of the user may be obtained. The specific notification and/or authorization manner may vary according to actual situations and application scenarios, and the scope of the present disclosure is not limited in this respect.

The solutions in the present specification and the embodiments, if personal information processing is involved, may be processed on the premise of having a legality basis (for example, obtaining consent of a personal information subject, or necessary for performing a fulfillment contract), and shall be processed only within a specified or agreed range. The user rejecting personal information other than necessary information required for the basic function would not affect the basic function of the user.

As described above, in general, the electronic device may generate media content with better creation effect based on the editing operation on the media content and the editing operation on the media resource in the interaction interface by the user. For example, the user may select a media resource provided by the electronic device to assist in implementing an effect application on the media content.

It should be understood that the media resources may be used to create digital content, including but not limited to effects, effect templates, filters, and other types of resources. For ease of understanding, an embodiment of the present disclosure takes an effect as an example of the media resource to describe the present disclosure.

Based on this, the electronic device may obtain an effect from the effect editing terminal, and some effect editing terminals allow a user (for example, a developer, an effect creation user, and the like) to customize the execution logic to be executed in the effect execution process by creating, dragging and connecting nodes with different functions, so as to conveniently and quickly generate the effect meeting the user's demand.

A node is a “dynamic creational node”, that is, a node that dynamically creates an object in an effect execution process. Based on the execution of the execution logic corresponding to the “dynamic creational node”, the electronic device may add the object created by the “dynamic creational node” to the editing interface or the editing scene of the media content. Types of objects include, but are not limited to, two-dimensional scene objects (2D scene objects), three-dimensional scene objects (3D scene objects), resource objects, script objects, and the like.

However, in some scenarios, frequent invocation of a node such as a “dynamic creational node” may cause an electronic device to generate a relatively large number of dynamic objects in an effect execution process. The increase in the generation number of dynamic objects may bring problems such as dramatic decrease in performance of the electronic device, an increase in running memory, crash of an application executing an effect, and the like.

Therefore, the conventional technology still has a large challenge in performing resource consumption and stability of media resources.

In view of this, embodiments of the present disclosure provide a solution for processing a media resource. According to the solution, may execute a media resource based on a selection of the media resource; furthermore, may determine, during an execution of the media resource and in response to an object creation request triggered by the media resource, a number of a set of objects generated by the media resource, where the set of objects is determined based on object category information indicated by the object creation request; furthermore, may create, in response to the number being less than a threshold, a first object corresponding to the object category information; and displaying the created first object in the interface.

Based on this manner, the embodiments of the present disclosure can determine, during a processing of the media resource and in response to an object creation request generated by the media resource, a number of a set of objects which have been generated, and create the first object in the case of the number is less than a threshold. Therefore, the embodiment of the invention can limit the number of dynamically created objects in the execution process of the media resources, so that the problems of reduced performance and the like caused by a large number of dynamic objects are avoided.

Therefore, the embodiment of the invention can reduce the performance consumption of the electronic device for executing the media resource and improve the stability of executing the media resource.

### Example Environment

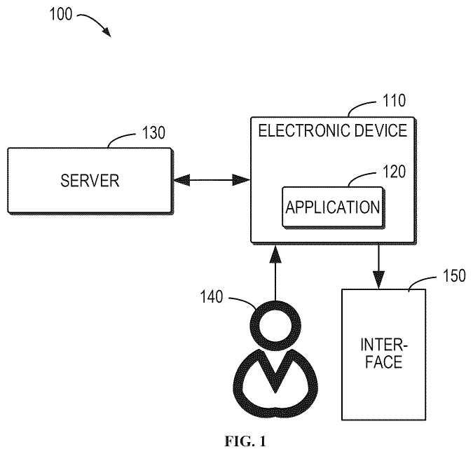

FIG. 1 illustrates a schematic diagram of an example environment 100 in which embodiments of the present disclosure can be implemented. As shown in FIG. 1, the example environment 100 may include an electronic device 110.

In this example environment 100, an application 120 is installed in the electronic device 110. The user 140 may interact with the application 120 via the electronic device 110 and/or its attachment device. The application 120 may be an application that supports execution of a media resource, for example, a media application, or any other suitable application.

In the environment 100 of FIG. 1, if the application 120 is in an active state, the application 120 may provide a presentation interface 150 for the user 140.

In some embodiments, the electronic device 110 communicates with the server 130 to enable provisioning of services to the application 120. Electronic device 110 may be any type of mobile terminals, fixed terminals, or portable terminals, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, etc.).

The server 130 may be an independent physical server, may also be a server cluster or a distributed system formed by a plurality of physical servers, and it may also be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, etc. The server 130 may provide background services for applications 120 that support content presentation in the electronic device 110.

A communication connection may be established between the server 130 and the electronic device 110. The communication connection may be established in a wired manner or a wireless manner. Communication connections may include, but are not limited to, Bluetooth connections, mobile network connections, universal serial bus connections, wireless fidelity connections, etc., embodiments of the present disclosure are not limited in this respect. In an embodiment of the present disclosure, the server 130 and the electronic device 110 may implement signaling interaction through a communication connection between the server 130 and the electronic device 110.

It should be understood that the structures and functions of the various elements in environment 100 are described for exemplary purposes only and do not imply any limitation to the scope of the disclosure.

Some example embodiments of the present disclosure will be described below with continued reference to the accompanying drawings.

### Example Interaction

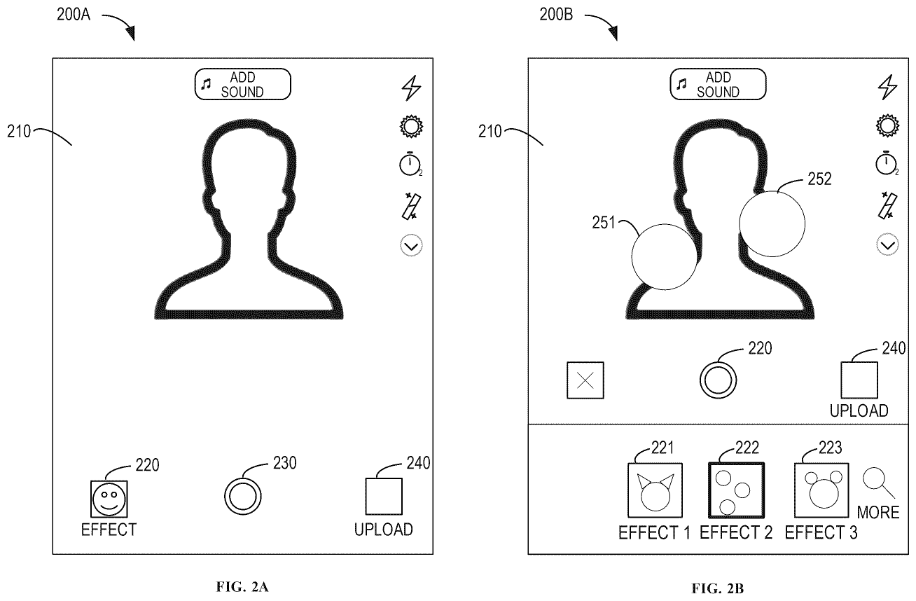

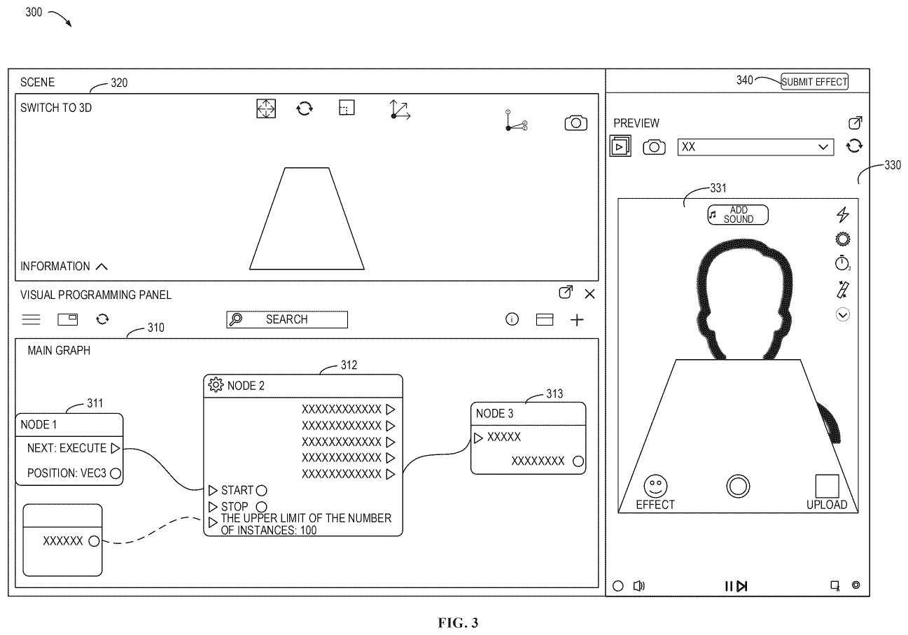

An example interaction process according to embodiments of the present disclosure will be described below with reference to FIG. 2A-FIG. 2B. FIG. 2A-FIG. 2B illustrate example interaction interface 200A—interaction interface 200B according to some embodiments of the present disclosure. The interaction interface 200A—interaction interface 200B may be provided by, for example, the electronic device 110 shown in FIG. 1.

As shown in FIG. 2A, the electronic device 110 may, for example, present an interactive interface 200A (an editing interface of media content). The interactive interface 200A may present a view-finding area 210. An image captured by, for example, an image acquisition device, or an image or video uploaded by a user, or the like may be displayed in the view-finding area 210. The interaction interface 200A may further comprise one or more controls, such as an effect control 220, a recording control 230, an upload control 240, or other implementable controls, such as lighting adjustment controls, music adding controls, and so on.

In some embodiments, the electronic device 110 may display, in response to a triggering operation of the user on the effect control 220, a plurality of effects for user selection, for example, the electronic device displays an effect 221 (effect 1), an effect 222 (effect 2), and an effect 223 (effect 3) as shown in FIG. 2B. Such an effect may be provided by the application 120, or may be imported or obtained by the user in an appropriate manner.

In some embodiments, the electronic device 110 may execute, in response to the trigger operation of the user for any effect, the effect selected by the user, for example, the user selects the effect 222, and the electronic device may execute the effect 222.

In some embodiments, after executing the effect 222, the electronic device 110 may further receive a trigger on the recording button 230 to collect the real-time image. Correspondingly, the effect 222 may be implemented on the acquired real-time image to apply a visual effect, an audio effect, and the like corresponding to the acquired real-time image to the effect 222.

In some embodiments, the effects 222 may, for example, be associated with the creation process of one or more objects. As shown in FIG. 2B, during execution of the effect 222, the effect 222 may trigger an object creation request for creating a specific object.

In some examples, the object creation request may be automatically created based on the effect execution logic of the effect 222, or may be created based on image processing of the image in the view-finding area 210 triggered, or may be created based on the interaction operation of the user with the image in the view-finding area 210 triggered during the execution of the effect 222, or in other suitable manner of creation, and the like.

In some examples, as shown in FIG. 2B, object 251 and object 252 may be virtual objects created during execution of effects 222, such as virtual spheres.

It should be understood that the specific effects and specific objects described in the foregoing embodiments are merely examples, and the present disclosure is not intended to limit the specific effect of the effect and the specific form and number of the objects.

In some other scenarios, the target effects described above may also be executed in an appropriate environment in other manners, for example, the effects may be applied to scenes such as image editing applications, video clipping applications, and the like.

In some embodiments, in a case that the number of objects generated by the effect execution gradually increases, the performance consumption of the electronic device 110 may also gradually increase. If the number of objects generated by the effect execution is relatively large, the performance of the electronic device 110 may decrease, thereby affecting the stability of the effect execution.

Based on this, in some embodiments, the electronic device 110 may, in response to the object creation request generated by the effect, determine a set of objects based on the object category information indicated by the object creation request, and determine the number of the set of objects that have been generated by the effect which has been triggered.

In some examples, the object may comprise the virtual object created above, that is, the instantiated object created during the effect execution process. The created objects may include, but are not limited to, two-dimensional scene objects, three-dimensional scene objects, resource objects, script objects, and the like.

In some embodiments, the object may be shown in the view-finding area 210 as shown in FIG. 2B for viewing by a user. For example, the object may comprise object 251, object 252, etc. in interface 200B.

In some example, the object creation request may indicate object category information, and thus a first object corresponding to the object category information may be created based on the object creation request. The object category information may be category information of an object to be created by the object creation request. The object category information may be divided based on object attribute information such as a shape of the object, a color of the object, or the like.

Multiple objects, corresponding to the same object category information, may correspond to the same template or template configuration. The template refers to the object creation template on which the creation of the first object (i.e., the first instance) depends. The template configuration contains configuration information to configure the template, and so on.

Further, the electronic device 110 may determine, based on the object category information indicated by the object creation request, a set of objects that have been generated by the effect and correspond to the object category information, and determine the number of the set of objects. The number of the set of objects is the number of objects contained in the set of objects, for example, the set of objects comprises the object 251 and the object 252, and the number of the set of objects may be 2.

In some embodiments, the electronic device 110 may determine, based on the object category information, whether the creation object is implemented based on one or more of the object templates. Specifically, the electronic device 110 may determine, in response to the object creation request triggered by the effect, whether the object creation request is associated with one or more of the object templates based on the object category information indicated by the object creation request.

In some examples, the object template is the above template, and the object template may be a predetermined object template or an object template determined in other manners.

Thus, the electronic device 110 may determine whether the object category information indicated by the object creation request has been associated with one or more of the object templates, that is, whether the object creation request creates the object based on the object template.

In some embodiments, the electronic device 110 may determine, based on the object template associated with the object creation request, a number of a set of objects that have been generated by the object template. Specifically, the electronic device 110 may determine, in response to the object creation request being associated with the object template, a number of a set of objects that have been generated based on the object template.

In some examples, the object creation request may be associated with one or more of object templates. For example, the object creation request may be configured to create one or more objects corresponding to one object category information, that is, the object creation request is associated with an object template. The object creation request may also be configured to create one or more objects corresponding to each object category information of the plurality of object category information, that is, the object creation request is associated with the plurality of object templates.

For example, the present disclosure takes the object template as an example. The electronic device 110 may determine, in response to the object creation request being associated with the object template, a number of a set of objects that the electronic device 110 has generated based on the object template. The set of objects refers to all the objects that the electronic device 110 has generated based on the object template.

Thus, the electronic device 110 may determine the number of objects that have been generated using the object template. The electronic device 110 may determine, based on the number of the set of objects, the performance consumption due to the response to the object creation instruction. For example, the larger the number of the set of objects, the more serious the performance consumption of the electronic device 110, and the larger the probability that the memory is insufficient and the application crashes.

In some embodiments, the object template may correspond to a template identifier. The template identifier may be, for example, a unique identifier of the object template, or any other suitable form of identifier, and the like.

Based on this, the electronic device 110 may quickly determine, based on the template identifier, a set of objects that have been generated based on the object template. Specifically, the electronic device 110 determines a template identifier of the object template, and determines, based on the template identifier, a set of objects that have been generated using the object template. Further, the electronic device 110 may determine the number of the set of objects.

In some embodiments, the object creation request is not associated with the object template, that is, the process, performed by the electronic device 110 to create the object in response to the object creation request, does not depend on the object template implementation. In order to control the number of objects dynamically generated by the effect, the electronic device 110 may determine the number of the set of objects based on the identification information of the node corresponding to the object creation request.

Specifically, the electronic device 110 may determine, in response to the object creation request not being associated with the object template, identification information of a node corresponding to the object creation request based on the object category information; and determine the number of a set of objects matching the identification information.

In some examples, a node may be a task node that contains an execution logic of an object creation request. The identification information of the node may be information which uniquely identify node, including but not limited to node coding information, node attribute information, node state information, node relationship information, node configuration information, and the like, or a plurality thereof.

In some embodiments, the identification information of the node may contain type information of the node and name information of the node, to indicate the type of the node and the name of the node. The identification information of the node is used to uniquely identify the node.

Based on this, the electronic device 110 may uniquely identify the object creation request using the identification information of the node. In the case that the object creation request is not associated with the object template, the number of the set of objects matching the identification information (i.e., the number of the set of objects corresponding to the object creation request) may be determined based on the identification information of the object creation request.

In some examples, the electronic device 110 responds to the object creation request generated by the effect to create a triangular three-dimensional scene object and display it in the interaction interface 200B. The object template contains a circular template and a square template. The electronic device 110 determines that the object creation request is not associated with the object template; and based on the object category information “triangle” indicated by the object creation request, the electronic device 110 determines identification information of a node corresponding to the object creation request, to uniquely identify the node used to create the triangular three-dimensional scene object. Further, the electronic device 110 determines the number of the generated triangle objects by determining the number of the set of objects matching the identification information of the node.

In some embodiments, to facilitate searching of a set of objects, the electronic device 110 may further construct a node identifier based on the identification information of the node, and determine the set of objects based on the node identifier, so as to increase the search speed. Specifically, the electronic device 110 may construct a node identifier based on the identification information of the node; and determine the set of objects matching the identification information based on the node identifier.

In some examples, the node identifier may be, for example, a unique identifier of the node, or any other suitable form of identifier, and the like. Based on the node identifier, a set of objects that have been generated using the node (i.e. all created objects that match the node identifier) may be quickly determined.

In some embodiments, in order to control the number of created objects, the electronic device 110 may perform object creation in the case that the number of the set of objects is less than a threshold. Specifically, the electronic device 110 may create, in response to the number of the set of objects being less than a threshold, a first object corresponding to the object category information, and display the created first object in the interface. Thus, the electronic device 110 may quickly respond to the object creation request based on the object template to create the first object and display the created first object.

In some embodiments, the threshold may be a predetermined number of the electronic device 110. The electronic device 110 may pre-configure an appropriate threshold based on the software information and/or hardware information of the electronic device 110, to ensure the performance of the electronic device.

In some embodiments, the threshold may also be the number that is set via the editing interface of the effect. In some examples, the editing interface of the effect is shown in FIG. 3. FIG. 3 illustrates a schematic diagram of an editing interface 300 according to some embodiments of the present disclosure. The editing interface 300 may be provided by the electronic device 110 shown in FIG. 1, or any other suitable electronic device. That is, the effect execution method and the effect editing method may be implemented by the same electronic device, or may be implemented by different electronic devices.

Hereinafter, an example explanation will be given by taking the editing interface 300 provided by the electronic device 110 as an example. As shown in FIG. 3, the electronic device 110 may present, for example, a node editing area 310, a scene preview area 320, an effect preview area 330, and an interaction control 340.

The node editing area 310 may present a node window corresponding to the node edited by the user, for example, a node window 311 corresponding to the node 1, a node window 312 corresponding to the node 2, and a node window 313 corresponding to the node 3 as shown in FIG. 3. Taking the user editing node 2 as an example, the electronic device 110 may obtain the number of instance objects (for example, 100) that is set by the user in the node window 313, so as to obtain the threshold of the present disclosure.

Further, based on the editing interface 300, the user may view the scene preview information of the effect through the scene preview area 320, preview the display effect of the effect through the effect preview area 330, submit the effect through interaction with the interactive control 340, and the like. For example, the user may preview the media content in the effect image 331 through the effect preview area 330.

Therefore, based on the number that is set by the user in the editing interface of the effect, the threshold of the present disclosure may better meet the needs of the user.

In some embodiments, in the case that the creation of the first object is completed, the electronic device 110 may record the first object, and provide data support for the next response to an object creation request. Specifically, the electronic device 110 may determine a first object identifier of the first object in response to the first object being created, the first object identifier being used to uniquely identify the first object; and record, in the storage module, a first association relationship between the object identifier and the corresponding template identifier or the node identifier.

In some examples, the electronic device 110 may calculate the first object identifier of the first object based on information such as a memory address of the first object.

The electronic device 110 may record, in response to the object creation request being associated with the object template, in the storage module a first association relationship between the object identifier and the corresponding template identifier; or the electronic device 110 may record, in response to the object creation request not being associated with the object template, in the storage module a first association relationship between the object identifier and the corresponding node identifier. The storage module may comprise any data storage module capable of storing, including but not limited to a hardware storage medium, a cloud storage service, and the like.

In some examples, the electronic device 110 uses the template identifier or the node identifier as a key, and uses the first object identifier as a value, and records the first association relationship in a key-value form into the storage module to improve data management efficiency.

In some embodiments, the electronic device 110 may further delete an association relationship related to the object, to ensure consistency of the data. Specifically, the electronic device 110 may determine, in response to an object deletion request generated by the media resource, a second object identifier of a second object that is to be deleted; and remove a second association relationship corresponding to the second object identifier from the storage module.

In some examples, the second object that is to be deleted may be the first object, or may be another object other than the first object, or the like. Removing the second association relationship corresponding to the second object identifier from the storage module may be implemented by deleting the second association relationship corresponding to the second object identifier from the storage module, or by moving the second association relationship corresponding to the second object identifier in the storage module to other memories, which is not limited in the present disclosure.

In some embodiments, there may be a situation that the number of the set of objects generated by the effect which has been triggered reaches the threshold. Based on this, the electronic device 110 may not perform object creation. Specifically, the electronic device 110 performs, in response to the number reaching the threshold, a subsequent process of the media resource without responding to the object creation request.

In some examples, the effect execution may be implemented by executing a plurality of tasks. Responding to the object creation request may be a part of the plurality of tasks. In response to the number reaching a threshold, the electronic device 110 may skip or block the part of tasks corresponding to responding to the object creation request, and continue to execute subsequent tasks, thereby implementing an execution process of the entire effect.

Based on this manner, the embodiment of the invention can limit the number of objects created by the object creation request in the execution process of the media resources, avoid the performance degradation problems of insufficient performance, insufficient running memory, crash of an application executing media resources and the like caused by a large number of the objects created, reduce the performance consumption of the electronic device for executing the media resources, and improve the stability of execution of the media resources.

Therefore, the embodiment of the invention can avoid the performance degradation, improve the stability of execution of the media resources, and can reduce the memory pressure of the storage module and improve the execution effect of the media resource.

### Example Processes

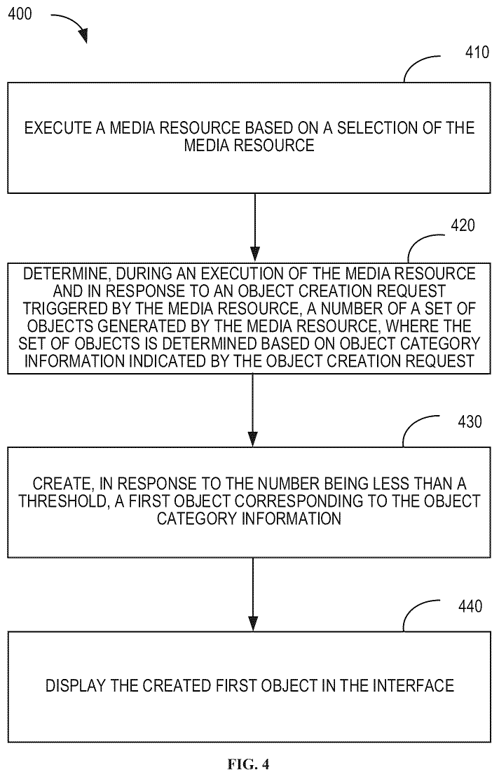

FIG. 4 illustrates a flowchart of an example process 400 of processing a media resource according to some embodiments of the present disclosure. The process 400 may be implemented at electronic device 110. The process 400 is described below with reference to FIG. 1.

At block 410, the electronic device 110 executes a media resource based on a selection of the media resource.

At block 420, the electronic device 110 determines, during an execution of the media resource and in response to an object creation request triggered by the media resource, a number of a set of objects generated by the media resource, where the set of objects is determined based on object category information indicated by the object creation request.

At block 430, the electronic device 110 creates, in response to the number being less than a threshold, a first object corresponding to the object category information.

At block 440, the electronic device 110 displays the created first object in the interface.

In some embodiments, determining, in response to the object creation request triggered by the media resource, the number of the set of objects generated by the media resource comprises: determining, based on the object category information, whether the object creation request is associated with an object template; and determining, in response to the object creation request being associated with the object template, the number of the set of objects generated based on the object template.

In some embodiments, the process 400 further comprises: determining a template identifier of the object template; and determining, based on the template identifier, the set of objects generated using the object template.

In some embodiments, the process 400 further comprises: determining, in response to the object creation request not being associated with the object template, identification information of a node corresponding to the object creation request based on the object category information; and determining the number of the set of objects matching the identification information.

In some embodiments, the process 400 further comprises: constructing a node identifier based on the identification information of the node; and determining, based on the node identifier, the set of objects matching the identification information.

In some embodiments, the identification information indicates a type of the node and a name of the node.

In some embodiments, the process 400 further comprises: determining a first object identifier of the first object in response to the first object being created, the first object identifier being used to uniquely identify the first object; and recording, in a storage module, a first association relationship between the object identifier and a corresponding template identifier or node identifier.

In some embodiments, the process 400 further comprises: determining, in response to an object deletion request generated by the media resource, a second object identifier of a second object that is to be deleted; and removing a second association relationship corresponding to the second object identifier from the storage module.

In some embodiments, the threshold is: a predetermined number; or a number that is set via an editing interface of the media resource.

In some embodiments, the process 400 further comprises: performing, in response to the number reaching the threshold, a subsequent process of the media resource without responding to the object creation request.

### Example Apparatus and Device

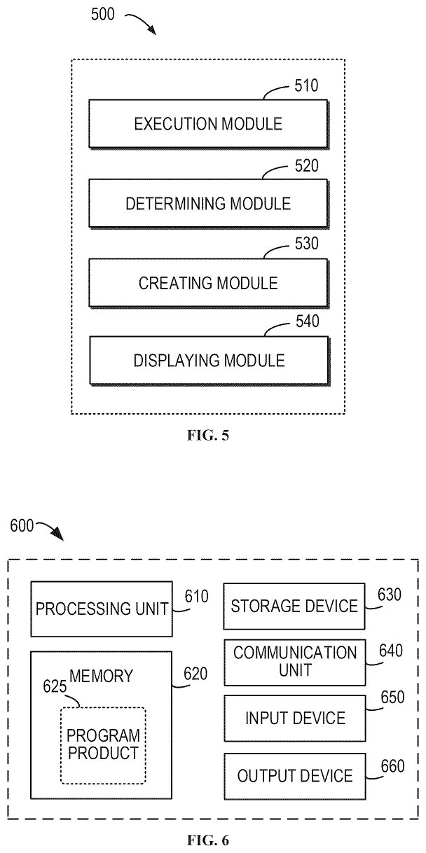

Embodiments of the present disclosure also provide a corresponding apparatus for implementing the above method or process. FIG. 5 illustrates a schematic structural block diagram of an apparatus 500 for processing a media resource according to some embodiments of the present disclosure. The apparatus 500 may be implemented as the electronic device 110 or included in the electronic device 110 as discussed above. The various modules/components in the apparatus 500 may be implemented by hardware, software, firmware, or any combination thereof.

As shown in FIG. 5, the apparatus 500 comprises an execution module 510 configured to execute a media resource based on a selection of the media resource; a determining module 520 configured to determine, during execution of the media resource and in response to an object creation request triggered by the media resource, a number of a set of objects generated by the media resource, where the set of objects is determined based on object category information indicated by the object creation request; a creation module 530 configured to create, in response to the number being less than a threshold, a first object corresponding to the object category information; and a display module 540 configured to display the created first object in an interface.

In some embodiments, the determining module 520 is further configured to: determine, based on the object category information, whether the object creation request is associated with an object template; and determine, in response to the object creation request being associated with the object template, the number of the set of objects generated based on the object template.

In some embodiments, the apparatus 500 further comprises a first object determination module configured to: determine a template identifier of the object template; and determine, based on the template identifier, the set of objects generated using the object template.

In some embodiments, the apparatus 500 further comprises a number determining module configured to: determine, in response to the object creation request not being associated with the object template, identification information of a node corresponding to the object creation request based on the object category information; and determine the number of the set of objects matching the identification information.

In some embodiments, the apparatus 500 further comprises a second object determining module configured to: construct a node identifier based on the identification information of the node; and determining, based on the node identifier, the set of objects matching the identification information.

In some embodiments, the identification information indicates a type of the node and a name of the node.

In some embodiments, the apparatus 500 further comprises a recording module configured to: determine a first object identifier of the first object in response to the first object being created, the first object identifier being used to uniquely identify the first object; and record, in a storage module, a first association relationship between the object identifier and a corresponding template identifier or node identifier.

In some embodiments, the apparatus 500 further comprises a deletion module configured to: determine, in response to an object deletion request generated by the media resource, a second object identifier of a second object that is to be deleted; and remove a second association relationship corresponding to the second object identifier from the storage module.

In some embodiments, the threshold is: a predetermined number; or a number that is set via an editing interface of the media resource.

In some embodiments, the apparatus 500 further comprises a continuing execution module configured to perform, in response to the number reaching the threshold, a subsequent process of the media resource without responding to the object creation request.

The units included in the apparatus 500 may be implemented in various forms, including software, hardware, firmware, or any combination thereof. In some embodiments, one or more units may be implemented using software and/or firmware, such as machine-executable instructions stored on a storage medium. In addition to or as an alternative to machine-executable instructions, some or all of the units in the apparatus 500 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

FIG. 6 illustrates a block diagram of an electronic device 600 capable of implementing one or more embodiments of the present disclosure. It should be understood that the electronic device 600 shown in FIG. 6 is merely for example and should not constitute any limitation on the function and scope of the embodiments described herein. The electronic device 600 shown in FIG. 6 may be configured to implement the electronic device 110 of FIG. 1 or the apparatus 500 of FIG. 5.

As shown in FIG. 6, the electronic device 600 is in the form of a general-purpose electronic device. Components of the electronic device 600 may include, but are not limited to, one or more processors or processing units 610, a memory 620, a storage device 630, one or more communication units 640, one or more input devices 650, and one or more output devices 660. The processing unit 610 may be an actual or virtual processor and capable of performing various processes according to programs stored in the memory 620. In multiprocessor systems, multiple processing units execute computer-executable instructions in parallel to improve parallel processing capabilities of electronic device 600.

The electronic device 600 typically includes a plurality of computer storage media. Such media may be any available media accessible by the electronic device 600, including, but not limited to, volatile and non-volatile media, removable and non-removable media. The memory 620 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 630 may be a removable or non-removable medium and may include a machine-readable medium, such as a flash drive, magnetic disk, or any other medium, which may be capable of storing information and/or data and may be accessed within electronic device 600.

The electronic device 600 may further include additional removable/non-removable, volatile/non-volatile storage media. Although not shown in FIG. 6, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 620 may include a computer program product 625 having one or more program modules configured to perform various methods or actions of various embodiments of the disclosure.

The communications unit 640 implements communications with other electronic devices over a communications medium. Additionally, the functionality of components of the electronic device 600 may be implemented in a single computing cluster or multiple computing machines capable of communicating over a communication connection. Thus, the electronic device 600 may operate in a networked environment using logical connections with one or more other servers, network personal computers (PCs), or another network node.

The input device 650 may be one or more input devices, such as a mouse, a keyboard, a trackball, or the like. The output device 660 may be one or more output devices, such as a display, a speaker, a printer, or the like. The electronic device 600 may also communicate with one or more external devices (not shown) through the communication unit 640 as needed, external devices such as storage devices, display devices, etc., communicate with one or more devices that enable a user to interact with the electronic device 600, or communicate with any device (e.g., a network card, a modem, etc.) that enables the electronic device 600 to communicate with one or more other electronic devices. Such communication may be performed via an input/output (I/O) interface (not shown).

According to example implementations of the disclosure, there is provided a computer-readable storage medium having computer-executable instructions stored thereon, where the computer-executable instructions are executed by a processor to implement the method described above. According to example implementations of the disclosure, a computer program product is further provided, the computer program product being tangibly stored on a non-transitory computer-readable medium and including computer-executable instructions, the computer-executable instructions being executed by a processor to implement the method described above.

Aspects of the disclosure are described herein with reference to flowcharts and/or block diagrams of methods, apparatuses, devices, and computer program products implemented in accordance with the disclosure. It should be understood that each block of the flowchart and/or block diagram, and combinations of blocks in the flowcharts and/or block diagrams, may be implemented by computer-readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce apparatus to implement the functions/acts specified in the flowchart and/or block(s) in block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block(s) in block diagram.

The computer-readable program instructions may be loaded onto a computer, other programmable data processing apparatus, or other devices, such that a series of operational steps are performed on a computer, other programmable data processing apparatus, or other devices to produce a computer-implemented process such that the instructions executed on a computer, other programmable data processing apparatus, or other devices implement the functions/acts specified in the flowchart and/or block(s) in block diagram.

The flowchart and block diagrams in the figures show architecture, functionality, and operation of possible implementations of systems, methods, and computer program products according to various implementations of the disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, the practical application, or improvements to the technology in the marketplace, or to enable others of ordinary skill in the art to understand the various implementations disclosed herein.

1. A method for processing a media resource, comprising:
executing a media resource based on a selection of the media resource;
determining, during an execution of the media resource and in response to an object creation request triggered by the media resource, a number of a set of objects generated by the media resource, wherein the set of objects is determined based on object category information indicated by the object creation request;
creating, in response to the number being less than a threshold, a first object corresponding to the object category information; and
displaying the created first object in the interface.

2. The method of claim 1, wherein determining, in response to the object creation request triggered by the media resource, the number of the set of objects generated by the media resource comprises:
determining, based on the object category information, whether the object creation request is associated with an object template; and
determining, in response to the object creation request being associated with the object template, the number of the set of objects generated based on the object template.

3. The method of claim 2, further comprising:
determining a template identifier of the object template; and
determining, based on the template identifier, the set of objects generated using the object template.

4. The method of claim 2, further comprising:
determining, in response to the object creation request not being associated with the object template, identification information of a node corresponding to the object creation request based on the object category information; and
determining the number of the set of objects matching the identification information.

5. The method of claim 4, further comprising:
constructing a node identifier based on the identification information of the node; and
determining, based on the node identifier, the set of objects matching the identification information.

6. The method of claim 4, wherein the identification information indicates a type of the node and a name of the node.

7. The method of claim 1, further comprising:
determining a first object identifier of the first object in response to the first object being created, the first object identifier being used to uniquely identify the first object; and
recording, in a storage module, a first association relationship between the object identifier and a corresponding template identifier or node identifier.

8. The method of claim 7, further comprising:
determining, in response to an object deletion request generated by the media resource, a second object identifier of a second object that is to be deleted; and
removing a second association relationship corresponding to the second object identifier from the storage module.

9. The method of claim 1, wherein the threshold is:
a predetermined number; or
a number that is set via an editing interface of the media resource.

10. The method of claim 1, further comprising:
performing, in response to the number reaching the threshold, a subsequent process of the media resource without responding to the object creation request.

11. An electronic device, comprising:
at least one processor; and
at least one memory coupled to the at least one processor and storing instructions for being executed by the at least one processor, the instructions, when executed by the at least one processor, causing the electronic device to perform acts comprising:
executing a media resource based on a selection of the media resource;
determining, during an execution of the media resource and in response to an object creation request triggered by the media resource, a number of a set of objects generated by the media resource, wherein the set of objects is determined based on object category information indicated by the object creation request;
creating, in response to the number being less than a threshold, a first object corresponding to the object category information; and
displaying the created first object in the interface.

12. The electronic device of claim 11, wherein determining, in response to the object creation request triggered by the media resource, the number of the set of objects generated by the media resource comprises:
determining, based on the object category information, whether the object creation request is associated with an object template; and
determining, in response to the object creation request being associated with the object template, the number of the set of objects generated based on the object template.

13. The electronic device of claim 12, wherein the acts further comprise:
determining a template identifier of the object template; and
determining, based on the template identifier, the set of objects generated using the object template.

14. The electronic device of claim 12, wherein the acts further comprise:
determining, in response to the object creation request not being associated with the object template, identification information of a node corresponding to the object creation request based on the object category information; and
determining the number of the set of objects matching the identification information.

15. The electronic device of claim 14, wherein the acts further comprise:
constructing a node identifier based on the identification information of the node; and
determining, based on the node identifier, the set of objects matching the identification information.

16. The electronic device of claim 14, wherein the identification information indicates a type of the node and a name of the node.

17. The electronic device of claim 11, wherein the acts further comprise:
determining a first object identifier of the first object in response to the first object being created, the first object identifier being used to uniquely identify the first object; and
recording, in a storage module, a first association relationship between the object identifier and a corresponding template identifier or node identifier.

18. The electronic device of claim 17, wherein the acts further comprise:
determining, in response to an object deletion request generated by the media resource, a second object identifier of a second object that is to be deleted; and
removing a second association relationship corresponding to the second object identifier from the storage module.

19. A non-transitory computer-readable storage medium storing a computer program thereon, the computer program, when executed by a processor, performing acts comprising:
executing a media resource based on a selection of the media resource;
determining, during an execution of the media resource and in response to an object creation request triggered by the media resource, a number of a set of objects generated by the media resource, wherein the set of objects is determined based on object category information indicated by the object creation request;
creating, in response to the number being less than a threshold, a first object corresponding to the object category information; and
displaying the created first object in the interface.

20. The non-transitory computer-readable storage medium of claim 19, wherein determining, in response to the object creation request triggered by the media resource, the number of the set of objects generated by the media resource comprises:
determining, based on the object category information, whether the object creation request is associated with an object template; and
determining, in response to the object creation request being associated with the object template, the number of the set of objects generated based on the object template.
